(19) United States
(12) Patent Application Publication
(10) Pub. No.: US 2026/0087035 A1
(43) Pub. Date: Mar. 26, 2026

(54) COMPUTER-IMPLEMENTED METHOD AND SYSTEM FOR IDENTIFYING AND ASSESSING INFRASTRUCTURE EQUIPMENT BASED ON ANALYSIS OF A DIGITIAL REPRESENTATION OF A GEOGPRAHIC REGION USING ARTIFICIAL INTELLIGENCE (AI) AND IMAGE PROCESSING AND ANALYSIS

(71) Applicant: PUREINTEGRATION, LLC, Reston, VA (US)

(72) Inventors: Michael LAPIERRE, Webster, NY (US); Sean O’NEILL, San Antonio, TX (US); Hejong Kim, McLean, VA (US)

(21) Appl. No.: 19/005,865

(22) Filed: Dec. 30, 2024

Related U.S. Application Data
(60) Provisional application No. 63/699,759, filed on Sep. 26, 2024.

(51) Int. Cl. G06F 16/29; G06F 16/587; G06T 7/13; G06V 10/25; G06V 10/764; G06V 20/10; H04N 23/58

(52) U.S. Cl. CPC G06F 16/29; G06F 16/587; G06T 7/13; G06V 10/25; G06V 10/764; G06V 20/176; H04N 23/58; G06T 2207/20081; G06V 2201/07

(57) ABSTRACT

A computer-implemented method of identifying, classifying, and assessing infrastructure equipment assets along routes in a geographic region by analyzing a digital representation of the geographic region using artificial intelligence (AI) and image analysis is provided. The method includes receiving a type of equipment to be audited and a geographic region; determining geographic coordinate information of a route in the geographic region; identifying, from a geographic image database, a polyline based on the geographic coordinate information; retrieving, from the geographic image database, based on the polyline, images; analyzing, using one or more machine learning (ML) models, the images to identify, classify, and assess assets associated with the equipment; generating a report that includes information associated with the identified assets and references to images of the identified assets; and initiating, based on the information in the report, an action associated with a record update, a record verification, and/or an infrastructure change recommendation.

### CROSS-REFERENCE TO RELATED APPLICATIONS

The present application claims priority to and the benefit of U.S. Provisional Ser. No. 63/699,759 entitled “Artificial Intelligence (AI) Visual System for Utility Equipment Auditing” and filed Sep. 26, 2024, which is hereby incorporated by reference in its entirety as if fully set forth below and for all applicable purposes.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Infrastructure systems, such as utility infrastructure systems, media infrastructure systems, telecommunications infrastructure systems, and fiber infrastructure systems, may include various equipment (e.g., power supplies, splice enclosures, line taps, telephony equipment, transformers, amplifiers, network elements, etc.). The equipment may be distributed throughout a geographic region (e.g., attached to utility poles located along roadways). Infrastructure systems may be owned by or deployed by various entities, such as multiple system operators (MSOs), utility companies, telephone companies, municipalities and government agencies that are responsible for public infrastructure, etc. Infrastructure equipment auditing may refer to the process of auditing or confirming the locations and/or status of equipment of an infrastructure system. In some examples, an infrastructure entity may perform regular equipment auditing for inventory management and/or operation efficiency improvement.

### SUMMARY

In an embodiment, a computer-implemented method of identifying and classifying infrastructure equipment assets along routes in a geographic region by analyzing a digital representation of the geographic region using artificial intelligence (AI) and computer image processing and analysis is provided. The method includes receiving, by a virtual audit application stored in non-transitory memory of a computer system and executable by a processor of the computer system, an indication of a type of equipment to be audited and a geographic region; determining, by the virtual audit application, based on a location map database, geographic coordinate information of a route in the geographic region; identifying, by the virtual audit application, from a geographic image database, a polyline representative of the route based on the geographic coordinate information; traversing, by the virtual audit application, a plurality of points on the polyline; retrieving, by the virtual audit application, from the geographic image database, based on geographic coordinate information associated with the plurality of points, a plurality of images of street views, each associated with a respective one of the plurality of points; analyzing, by the virtual audit application, using one or more machine learning (ML) models, the plurality of images to identify and classify assets associated with the equipment, wherein the analyzing comprises adjusting views of the plurality of images for use by the one or more ML models; generating, by the virtual audit application, a report that includes information associated with the identified assets and references to images of the identified assets; and initiating, by the virtual audit application, based on the information in the report, an action associated with at least one of a record update, a record verification, or an infrastructure change recommendation.

In another embodiment, a computer-implemented method of evaluating and updating a machine learning (ML) model for virtual auditing of infrastructure equipment based on rules associated with characteristics of the infrastructure equipment is provided. The method includes receiving, by a virtual audit application stored in non-transitory memory of a computer system and executable by a processor of the computer system, a type of equipment to be audited and a geographic region; retrieving, by the virtual audit application, a plurality of images of the geographic region; analyzing, by the virtual audit application, using one or more ML models, the plurality of images to identify and classify assets associated with the equipment, wherein the analyzing comprises processing a first image of the plurality of images using a first ML model of the one or more ML models to identify a first asset of the assets; determining, by an ML model training application stored in the non-transitory memory of the computer system and executable by the processor of the computer system, that the first ML model fails to identify one or more other assets associated with the equipment based on rules associated with characteristics of the equipment; and updating, by the ML model training application, based on the determining, one or more parameters of the first ML model.

In yet another embodiment, a computer-implemented method of updating an audit of infrastructure equipment in a geographic region by analyzing a digital representation of the geographic region using artificial intelligence (AI) and computer image processing and analysis is provided. The method includes receiving, by a virtual audit application stored in non-transitory memory of a computer system and executable by a processor of the computer system, a type of equipment to be audited, a geographic region, and a previous audit record of the type of equipment in the geographic region; determining, by the virtual audit application, a route in the geographic region; retrieving, by the virtual audit application, from a geographic image database, first image acquisition timestamp information associated with a plurality of first images corresponding respectively to a plurality of locations along the route; comparing, by the virtual audit application, the first image acquisition timestamp information to second image acquisition timestamp information associated with a plurality of second images of assets associated with the equipment identified at the plurality of locations in the previous audit record; determining, by the virtual audit application, based on the comparing, that at least one of the plurality of first images associated with a first location of the plurality of locations is acquired more recently than a respective one of the plurality of second images associated with the same first location; analyzing, by the virtual audit application, using one or more machine learning (ML) models, the at least one of the plurality of first images that is acquired more recently to identify and classify assets associated with the equipment; and updating, by the virtual audit application, the previous audit record based on information about the assets identified from the at least one of the plurality of first images that is acquired more recently.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, where like reference numerals represent like parts.

FIG. 1 is a block diagram of a network system for performing virtual infrastructure equipment auditing using artificial intelligence (AI) and computer image processing and analysis according to an embodiment of the disclosure.

FIG. 2 is a flow chart of an example method of performing virtual infrastructure equipment auditing using AI and computer image processing and analysis according to an embodiment of the disclosure.

FIG. 3 illustrates an example location map data according to an embodiment of the disclosure.

FIGS. 4A and 4B illustrate an example method of locating images from a geographic image database for virtual infrastructure equipment auditing according to an embodiment of the disclosure.

FIGS. 5A-5E illustrate an example method of processing images using AI and computer image processing and analysis for virtual infrastructure equipment auditing according to an embodiment of the disclosure.

FIG. 6 illustrates example data generated from virtual infrastructure equipment auditing according to an embodiment of the disclosure.

FIG. 7 illustrates an example graphical view of a virtual infrastructure equipment auditing result according to an embodiment of the disclosure.

FIG. 8 illustrates an example method of training a machine learning (ML) model for virtual infrastructure auditing according to an embodiment of the disclosure.

FIG. 9 is a flow chart of a method according to an embodiment of the disclosure.

FIG. 10 is a flow chart of another method according to an embodiment of the disclosure.

FIG. 11 is a flow chart of yet another method according to an embodiment of the disclosure.

FIG. 12 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Infrastructure systems including utility infrastructure systems, media infrastructure systems, telecommunications infrastructure systems, fiber infrastructure systems, as well as others, are often burdened with equipment and/or network elements that, over time, become outdated, redundant, or fall out of service. This can be problematic because outdated hardware and attachments (e.g., power supplies, splice enclosures, line taps, telephony equipment, transformers, amplifiers, network elements, etc.) continue to incur maintenance and operation costs, which drains resources without adding values. Additionally, inventory management practices often lead to inaccuracies in asset records, causing inadvertent payment for decommissioned equipment. Further, technological advancements are moving at such a fast pace rendering existing equipment and/or network elements obsolete, thereby making it challenging to keep infrastructure records up to date.

Regular infrastructure equipment audits are beneficial for a number of reasons including, but not limited to, extending the life of the equipment and/or network element, improving lifecycle planning for the equipment and/or network element, and aiding in compliance with regulatory obligations. However, traditional infrastructure equipment audits often involve physical inspection of the equipment and/or network elements, which is both resource intensive and costly. For instance, a utility company may audit utility equipment in a geographic region by deploying human workers to walk or drive along each street in that geographic region to locate utility poles and corresponding equipment attached to those poles. A human worker may only physically inspect or audit equipment along a route of about 3 miles in one shift (e.g., about 8 hours). In some instances, a city or town may have hundreds or thousands of street miles or route miles. As such, it may take weeks or months to complete an audit in a city or town.

The present disclosure provides a technical solution to the aforementioned technical problems in the technical field of infrastructure equipment auditing to provide a virtual audit system (e.g., a computer system) and method that streamlines the audit and inventory process for infrastructure. The virtual audit system and method may be cloud-based and may leverage computer image processing and analysis and artificial intelligence (AI) technologies. More specifically, the virtual audit system may audit infrastructure equipment in a geographic region by analyzing a digital representation of the geographic region (e.g., a database of streets or routes and corresponding geographic images of street views in the geographic region) virtually using computer image processing and analysis and AI technologies (e.g., machine learning (ML) models trained for image analysis, such as asset identification and classification). For instance, the virtual audit system may perform virtual walk along routes in the geographic region based on the digital representation of the geographic region and analyze images of street views along the routes using ML models to identify and classify assets related to the equipment and assess conditions of the identified assets.

There are various challenges in performing a virtual walk in the virtual world (e.g., digital representation of the geographic region) to locate, identify, and assess infrastructure equipment. For instance, a job request for infrastructure audit may often indicate a city, a town, a state, or a zip code for the audit. However, a database that includes street address information of a city, a town, a state, or a zip code is often separate from a database that includes geographic images maintained by different entities. To resolve the street information and geographic images being in different databases, the virtual audit system performs an alignment or mapping of information between different databases. Additionally, while a geographic image database may store images of views along an entire road (e.g., from captured videos) and geographic coordinate information of the corresponding road, the geographic coordinate information of the road may be sparse. For instance, the geographical image database may store geographic coordinates of sparsely-spaced points along the road (e.g., spaced further apart than locations of assets installation along the road). To overcome the sparse geographic coordinate information, the virtual audit system interpolates the geographic coordinate information so that the virtual walk may cover all assets installation along the road. Further, because the geographic images are captures of street views and may be captured under various conditions (e.g., lighting conditions, camera angles, etc.), the views of geographic images may not be optimal for infrastructure asset identification and assessment, especially when some assets may be attached near the top of utility poles and some assets may be installed at a ground level. To overcome the image qualities and/or the focus or angles of the images, the virtual audit system applies a series of camera bearing, pitch, and/or field of view (FOV) adjustments (e.g., image processing) to obtain an optimal view of the images for ML processing. The virtual audit system may interleave image view adjustments with ML processing to increase the accuracy of the ML processing. The various processing to overcome these challenges will be discussed more fully below. Because the virtual audit system performs the virtual walk and asset identification and analysis using computer image processing and analysis and ML processing, the virtual audit system may be significantly more efficient than a human worker performing physical walk (or drive) and equipment auditing. For example, the virtual audit system may cover over 20 miles of equipment auditing in about an hour while a human worker may only cover about 3 miles of equipment auditing in about 8 hours.

According to an embodiment of the present disclosure, the virtual audit system may include a computer system including a virtual audit application that performs virtual infrastructure equipment auditing. The virtual audit application may receive a job request to audit a certain type of equipment in a geographic region. The geographic region may be indicated by street addresses, a city, a town, a zip code, and/or a geofence (e.g., a virtual perimeter of a real-world geographic area). The type of equipment may be part of, for example, but not limited to, a utility infrastructure system, a telephony infrastructure system, a fiber infrastructure system, or a hybrid fiber-coaxial network system. The type of equipment may include, but is not limited to, a power supply, a splice enclosure, telephony equipment, a tap, an amplifier, or a transformer.

To begin the virtual audit, the virtual audit application may determine a route in the geographic region and determine geographic coordinate information of the route (e.g., a set of latitude and longitude coordinates along the route). In an embodiment, the virtual audit application may determine the route and corresponding geographic coordinate information from a location map database based on the indicated geographic region. In some instances, the location map database may be maintained by a state, a city, a county, a government agency, or a certain organization. The location map database may include indications (e.g., street names) of streets (in real world) and corresponding geographic coordinates (e.g., each represented by a latitude and a longitude). In an example, the location map database may store geographic information of a street in the form of a series of geographic coordinates, each corresponding to a starting location or an ending location of a respective segment of the street.

After determining the route and corresponding geographic coordinate information, the virtual audit application may identify, from a geographic image database, a polyline representative of the route based on the geographic coordinate information of the route. A polyline may include a sequence of points connected by line segments, where each point represents a geographic location along a corresponding walkable or drivable path in the real world. The geographic image database may store a polyline in the form of a series of geographic coordinates, each corresponding to a respective point on the polyline. In an example, the geographic image database may further include images (e.g., panoramic images) of street views captured at locations along a path or route in the real world and may store the images in association with a polyline corresponding to that path. The geographic image database may further include a geographic coordinate (e.g., stored as part of metadata) for each stored image, where the geographic coordinate may correspond to the location at which the respective image was captured. The geographic coordinate of an image may fall on a corresponding polyline or at a vicinity of the corresponding polyline. In an embodiment, as part of identifying the polyline representative of the route, the virtual audit application may compare geographic coordinate information of the route and geographic coordinate information of polylines in the geographic image database. For instance, the virtual audit application may search for the polyline with a geographic coordinate closest to the geographic coordinate of a starting location of the route.

After identifying the polyline representative of the determined route, the virtual audit application may traverse points on the polyline to retrieve images of street views along the route. For instance, at each traversed point, the virtual audit application may retrieve a respective one of the images associated with the respective traversed point (e.g., in a proximity of the traversed point). More specifically, the virtual audit application may search for an image associated with a particular point on the polyline based on a geographic coordinate of that particular point (obtained from the geographic image database).

In some instances, the geographic coordinate information of the identified polyline in the geographic image database may be sparse. For instance, the geographic image database may store geographic coordinates for the polyline at every 50, 100, 200, or 300 meters. However, in some cases, infrastructure equipment may be installed along a route spaced apart by a shorter distance (e.g., of about 1, 2, 3, 4, 5, 10, or 20 meters). As such, the geographic coordinate information provided by the geographic image database for the polyline may not have a sufficient granularity for the virtual audit application to perform the virtual walk to audit the equipment. To overcome the sparsity of the polyline geographic coordinate information, the virtual audit application may retrieve, from the geographic image database, geographic coordinates of points (e.g., a set of second points) on the identified polyline and interpolate the retrieved geographic coordinates to compute geographic coordinates for additional points between the second points. Stated differently, the virtual audit application may compute geographic coordinates of at least some of the points on the polyline for the virtual walk based on an interpolation of the retrieved geographic coordinates.

Further, in some instances, the images in the geographic image database may be updated from time-to-time (e.g., by the organization that captures and maintains the geographic image database). However, the updated images may or may not be captured at the same geographic locations as previously captured images. For instance, a current image (of a street view) may be captured at a location offset (e.g., by about 2, 4, 6, 8, 10 or more feet to the north (N), south (S), east (E), west (W), north-east (NE), north-west (NW), south-east (SE), or south-west (SW)) from a location where a previous image was captured. In an example, the geographic image database may store the updated images in addition to the previously captured images. As such, the geographic image database may include multiple images of street views at about the same geographic location that are acquired at different times. To facilitate identification of previously acquired images and currently updated images, the geographic image database may further include timestamp information (e.g., stored as part of metadata) for each image stored in the geographic image database. The timestamp information may indicate a date and/or a time when the respective image is captured in the real world.

Accordingly, in an embodiment, to retrieve an image associated with a particular point (e.g., a first point of the traversed points) along the polyline, the virtual audit application may further search for a most recent image in a proximity of the particular point (e.g., closest to the particular point). To that end, the virtual audit application may obtain, from the geographic image database, timestamp information (e.g., image acquisition dates and/or times) of images of the particular point on the polyline and/or multiple neighboring points (e.g., second points) proximal to the particular point and compare the timestamp information to select the image with the most recent timestamp. In an embodiment, the neighboring points may correspond to intersection points of a grid overlaid on top of the polyline and centered at about the particular point. In an example, the neighboring points may be at a distance of about 4, 6, 8, 9, or 10 feet from the particular point (e.g., depending on the dimensions of the grid) location and may be to the N, S, E, W, NE, NW, SE, or SW of the particular point. In an example, the geographic image database may further include, for each image in the geographic image database, an image identifier (e.g., stored as metadata) that uniquely identifies the image in the geographic image database and may associate the image identifier with corresponding timestamp information (e.g., date and/or time when the respective image is captured). Accordingly, in an embodiment, the virtual audit application may select an image identifier associated with a most recent timestamp from image identifiers associated with the particular point and the neighboring points (proximal to the particular point). Subsequently, the virtual audit application may retrieve the image identified by the selected image identifier.

After retrieving the images from the geographic image database, the virtual audit application may analyze the retrieved images using one or more ML models trained to identify and classify assets (e.g., poles and attachments on the poles) associated with the equipment and assess a condition of each of the identified assets. As discussed above, the images may be panoramic images of street views at corresponding locations. Accordingly, as part of analyzing the images, the virtual audit application may apply, to each retrieved image (corresponding to a respective point along the polyline), a first camera bearing adjustment (e.g.,−90 degrees) and a second camera bearing adjustment (e.g., +90 degrees) to respectively obtain a left-side (LS) view image and a right-side (RS) view image at the respective point. The virtual audit application may further adjust and optimize views of those LS view images and RS view images for use by the one or more ML models to identify and classify the assets associated with the equipment (in those LS view images and/or RS view images). For instance, the virtual audit application may analyze a particular image (e.g., a LS view image or a RS view image) by applying a series of image view adjustments (e.g., camera bearing adjustments, pitch adjustment, and/or FOV adjustments) interleaved with ML processing. Applying camera bearing and/or pitch adjustment to an image may frame the image to focus on a subject of interest (e.g., poles and/or asset). Applying an FOV adjustment to an image may effectively obtain a higher resolution image (at least until the adjustment reaches the resolution of the originally captured image). Interleaving image view adjustments with ML processing can improve the accuracy of the ML model (e.g., for identifying and classifying infrastructure equipment assets).

In an embodiment, the virtual audit application may process an image using an ML model (e.g., one of the one or more ML models) and determine whether an asset of the equipment is identified and whether the result (e.g., the confidence score of the identified asset, the view of the identified asset, the image quality, etc.) is satisfactory. For instance, the virtual audit application may determine whether the confidence score of the identified asset meets a certain threshold. The virtual audit application may also determine whether the identified asset is at about the center of the image. If the result is unsatisfactory, the virtual audit application may adjust a camera bearing and/or an FOV of the image (e.g., to center the image) based on the output of the ML model and repeat the ML processing (inference). The operations of ML processing and camera bearing and/or FOV adjustments may be repeated until a satisfactory result is obtained. Generally, the virtual audit application may apply various image processing techniques (e.g., contrast enhancement, noise reduction, color correction, image resizing, resolution enhancement, equalization, filtering, etc.) to improve the quality of an image prior to applying ML processing to identify the assets.

In an embodiment, because infrastructure equipment may be attached on poles as discussed above, the virtual audit application may perform the analysis by first identifying at least a pole in a LS view image or a RS view image (e.g., a first adjusted image) and subsequently zooming into the first adjusted image with the pole as the center of the image for subsequent analysis. To that end, the virtual audit application may process the first adjusted image, using a first ML model of the one or more ML models, to identify a pole and one or more of the assets on the pole in the first adjusted image. The first ML model may output a bounding box, a classification, and a corresponding confidence score for the identified pole and for each of the one or more identified assets. The virtual audit application may record information associated with the pole output by the first ML model (e.g., a classification and corresponding confidence score for the pole and coordinate information of a bounding box enclosing the pole).

After identifying the pole, the virtual audit application may adjust a camera bearing and an FOV of the first adjusted image (e.g., zooming into the first adjusted image) to generate a second adjusted image centered at the pole. After centering the second adjusted image at the pole, the virtual audit application may further zoom into the second adjusted image to provide a better view of the pole and assets for further ML processing. To that end, the virtual audit application may compute an asset enclosing bounding box enclosing all of the one or more assets identified on the pole and overlay the asset enclosing bounding box onto the second adjusted image. Next, the virtual audit application may adjust a camera bearing, a pitch, and an FOV of the second adjusted image to generate a third adjusted image centered at the computed asset enclosing bounding box.

After centering the asset enclosing a bounding box (enclosing all the one or more assets on the pole) in the third adjusted image, the virtual audit application may process the third adjusted image, using a second ML model of the one or more ML models, to identify the pole and the one or more assets on the pole in the third adjusted image. The second ML model may output a bounding box, a classification, and a corresponding confidence score for the identified pole and for each of the one or more identified assets. In some instances, the first ML model and the second ML model may output different confidence scores for the same identified asset. In some instances, for the same asset, the second ML model may output a higher confidence score than the first ML model (e.g., because of the higher resolution provided by FOV adjustments applied to the second adjusted image). The virtual audit application may record information output by the second ML model (e.g., a classification and corresponding confidence score for each identified asset and coordinate information of a bounding box enclosing the respective asset). In some instances, the first ML model and the second ML model may correspond to the same ML model (e.g., a single ML model used for object identification and classification). In other instances, the first ML model and the second ML model may correspond to different ML models (e.g., having different architectures and/or trained using different image sets, etc.). In some instances, the adjusting of camera bearings and/or FOVs may be performed using other ML models trained for optimizing imaging views. In other instances, the adjusting of camera bearings and/or FOVs may be performed using traditional image processing techniques. As discussed above, the FOV adjustments can effectively increase the image resolution. Thus, the iterative image processing (e.g., the FOV adjustments) interleaved with ML processing can allow the ML models to provide more accurate assessments of pole(s) and/or equipment assets in the images.

Subsequently, the virtual audit application may generate a report detailing all the identified assets within the defined geographic region. The report may include location information, asset type information, asset count information, and/or one or more links to images. In an example, the report may include a classification (e.g., an asset type) of the respective identified asset and a corresponding confidence score (output by the second ML model), an image identifier identifying a respective one of the images including the respective identified asset, a geographic coordinate associated with the respective image, image acquisition timing information associated with the respective image (e.g., a timestamp obtained from the geographic image database), coordinates of a bounding box that encloses the respective identified asset (output by the second ML model), a camera bearing associated with the respective identified asset, an FOV associated with the respective identified asset, and/or a pitch associated with the respective identified asset. The report may also include similar information for each identified pole carrying respective identified assets but the confidence score and the bounding box for the pole may be obtained from the output of the first ML model.

In some instances, the FOV, the camera bearing, and/or the pitch associated with the respective identified asset may be computed by the virtual audit application. In some examples, the report may be provided via a web-based dashboard. In some instances, the report may include one or more links to images (e.g., the images in the geographic image database used for locating the assets and/or the third adjusted images with bounding boxes) and corresponding confidence scores for respective identified assets and poles for visual verification and/or further analysis. In some instances, the images of the identified assets may be included as part of the report. In an embodiment, as part of analyzing the images, the virtual audit application may assess the conditions of the identified assets (e.g., whether an identified asset is connected or disconnected, active or inactive, etc.).

The virtual audit application may take various actions based on the generated report. In an embodiment, the virtual audit application may cross-correlate the information in the report with a company's internal audit records. In an embodiment, the virtual audit application may update records based on the report and recommend infrastructure changes to promote greater efficiency (in terms of cost savings and/or resource/energy consumption savings). In an embodiment, the virtual audit application may promote enhanced security by uncovering vulnerabilities in outdated systems and enable actions to address security risks. For instance, the virtual audit application may recommend, based on the report, to remove a certain outdated, decommissioned, or disconnected equipment (that is no longer in use). In some instances, the virtual audit application may recommend, based on the report, to install additional infrastructure equipment to improve operational efficiency. In some instances, the virtual audit application may recommend, based on the report, to replace a certain outdated infrastructure equipment with more secure infrastructure equipment (e.g., with more advanced security features). In an example, the infrastructure company may dispatch, based on the recommendation, a worker to service (e.g., repair or replace) the attachments or assets and/or install additional equipment (e.g., more advanced equipment).

In an embodiment, when the virtual audit application receives a subsequent request to audit the same type of equipment in the same geographic region, the virtual audit application may perform the audit efficiently by processing only images (of street views in the geographic region) that are updated in the geographic image database. To that end, when the virtual audit application traverses the polyline, the virtual audit application may search, at each location along the determined route, for an image from the geographic image database that is closest to the respective location and most currently acquired. The virtual audit application may compare the timestamp of that found image to the timestamp of the image used for the previous audit (e.g., stored in the audit report or the audit record). If there is a more currently acquired image for the respective location, the virtual audit application may repeat the same analysis as discussed above to identify assets and update the audit record accordingly. Otherwise, the virtual audit application may skip the analysis for that image, thereby promoting more efficient processing.

In an embodiment, the virtual audit system may further include an ML model training application that trains an ML model (e.g., the first model and/or the second ML model discussed above) to be used for identifying equipment assets from geographic images (of street view). The training may be based on a training data set including training images (e.g., for input to the ML model) and corresponding annotated images (e.g., that provide ground truths). The training images may be images of street views captured in the real world along walkable or drivable paths or routes (e.g., under various conditions, such as different lightings, different weathers, different seasons, different landscapes, etc.). The training images may include assets associated with the infrastructure equipment attached to poles. Each training image may have a corresponding annotated image. The corresponding annotated image be the same as the respective image and may further include bounding boxes enclosing respective assets and poles and corresponding labels (e.g., indicating a classification of the asset or pole). The ML model training application may input each training image to the ML model, and the ML model may process the training image to identify objects or assets associated with the equipment. The ML model training application may compare the output of the ML model to a corresponding ground truth (the annotations for the respective image) to determine an error. The ML model training application may update parameters of the ML model based on the error. The ML model training application may repeat the training process until the error satisfies a threshold. The ML model training application may repeat the training process for each training image in the training dataset. The trained ML model may be used for inference for virtual auditing of infrastructure equipment as discussed above.

To enable automatic re-tuning of the ML model, the ML model training application may apply additional rules to assess the ML model output. The rules may be associated with characteristics of the equipment. In some instances, the rules may include an indication of a coexistence between a first type of asset and a second type of asset for the equipment. That is, if the ML model identifies an asset of the first type in an image but not an asset of the second type, the ML model training application may determine that the ML model missed identifying the asset of the second type. As an example, if a transmission wire and a fuse cutout are attached to a pole, then there has to be a tap connected in parallel with the transmission wire. In some instances, the rules may specify steps for further training the ML model. As an example, if an asset is identified from an image by the ML model but with a low confidence score, that image is secondarily reviewed (e.g., based on the rules). If the asset is positively confirmed as the asset type identified in the initial analysis, the asset is recaptured and used for additional training. For instance, the ML model may identify a utility pole in an image but with a low confidence score of 60%. That image is reviewed a second time. If the second review determines that the asset is a utility pole with a high confidence or certainty, that initial image is used for further training of the ML model to capture the variables that resulted in the low confidence score. In some instances, the rules may include a comparison of assets identified by the ML model to an external data source (e.g., a company's internal record) having records of assets associated with the equipment. Generally, the rules may be implemented as software processing logics to be applied to the inference output of the ML model to determine missing assets and initiate further training of the ML model.

Continuous retraining or retuning the ML model with rules after deployment and subsequently deploying the updated ML model can be beneficial as there are numerous street views that the ML model may not have encountered during an initial training of the ML model, and, in some cases, those views may be at very specific locations. Generally, different geographic regions may have different specific geographic features. For instance, in one scenario, a utility pole may be located along a street with trees or a forest behind the utility pole. Because utility poles are typically wood poles (made from trees), it may be challenging for the ML model to accurately identify the utility pole and not to mis-identify a tree as a utility pole. In another scenario, a utility pole may be located next to a house with a wood chimney. Because of the height and the wood material of the chimney, it may be challenging for the ML model to accurately identify the utility pole and not to mis-identify the chimney as a utility pole.

In a further embodiment, the virtual audit application may further apply an ML model trained to perform segmentation to process images (retrieved from the geographic image database). The segmentation may provide further information associated with the geographic locations of the identified assets. That is, the virtual audit application may provide a geographic coordinate of the location of a pole along the route and a geographic coordinate of the location of each asset associated with the infrastructure equipment attached to the pole. The ML model for segmentation may be trained using substantially similar training mechanisms as discussed above but the labels in the annotated images may further include geographic coordinate information of the pole(s) and asset(s) in the respective images.

The pending application address and overcomes several specific technical challenges. One challenge is the development and refinement of virtual audit routes for efficiently parsing the relevant geographic keyed image data (e.g., the geographic image database) to align with and map to the target data (e.g., relevant images of routes for auditing) for the analysis and review. Another challenge relates to optimization of the views (e.g., the camera bearing adjustments and FOV adjustments) for most effective AI analysis for audit purposes. The training and tuning of the AI systems (e.g., the ML models) to effectively identify and audit key characteristics provides additional challenges. Finally, the iterations between starting known data, additionally discovered data, and refinement of computer image processing and analysis and efficient review of the geographically keyed images to create the audit packages for the identified sites and elements in that data creates a sequence of challenges being overcome.

By leveraging AI technology and integrating with geographical databases of images, the virtual audit system disclosed herein provides an efficient, accurate, cost-effective, and user-friendly system for management and maintenance of infrastructure equipment. The virtual audit system provides efficient auditing of infrastructure equipment by analyzing geographic images of a geographic region using computer image processing and analysis and AI technologies. For example, the virtual audit system may audit infrastructure equipment in a city or town within hours or days compared to a human worker taking weeks or months to physically audit the infrastructure equipment in the city or town, thereby improving efficiency and reducing the need for on-site visits and manual labor. Additionally, mapping and aligning routes in the real world to polylines in a geographic image database and retrieving images of street views along the polylines can ensure that the retrieved images correspond to street views along the routes, and thus enable the virtual audit system to audit infrastructure equipment virtually. Using most currently acquired images in the geographic image database can ensure that the analysis for the virtual audit is performed for most updated equipment installation along the routes. Further, utilizing knowledge (or characteristics) related to the particular type of infrastructure equipment to train and tune the ML models can improve the accuracy of the ML models and enable continual tuning and refining of the ML models during training and/or during operation (inference) time. While the present disclosure is discussed in the context of auditing infrastructure equipment, similar mechanisms can be applied to audit other objects (e.g., building structures, houses, schools, bridges, street lights, etc.).

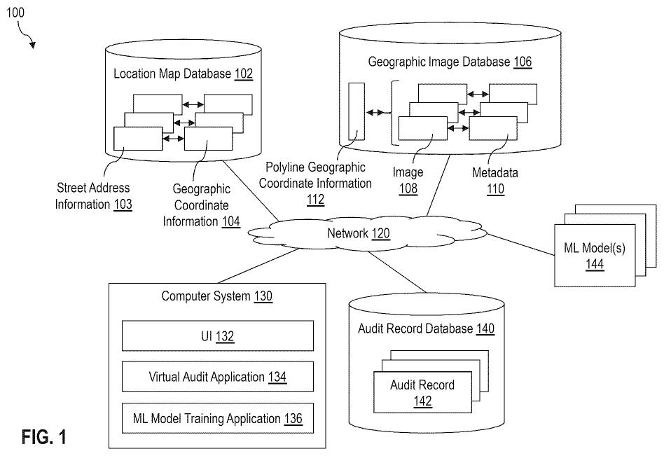

Turning now to FIG. 1, a network system 100 is described. The network system 100 may be a cloud-based system. The network system 100 may be used for auditing infrastructure equipment in a geographic region by analyzing a digital representation of the geographic region using AI and computer image processing and analysis technologies. As shown in FIG. 1, the network system 100 includes a location map database 102, a geographic image database 106, a network 120, a computer system 130 (a virtual audit system), an audit record database 140, and one or more ML models 144. The network 120 promotes communication between the components of the network system 100. The network 120 may be any communication network including a public data network (PDN), a public switched telephone network (PSTN), a private network, and/or a combination.

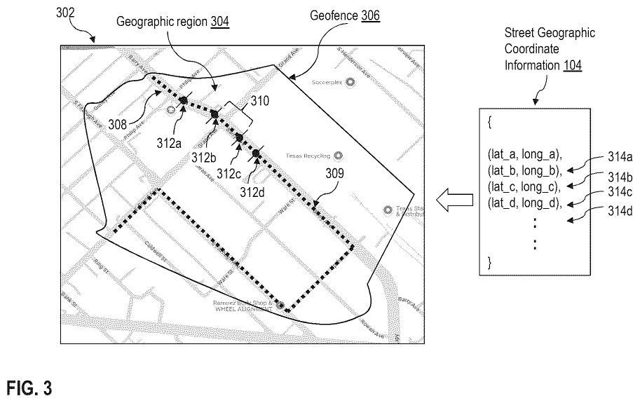

The location map database 102 may include location, shape, and attributes of geographic features. In an example, the location map database 102 may include street address information 103 and corresponding geographic coordinate information 104 (e.g., latitudes and longitudes). The street address information 103 may store addresses in various forms, for example, including fields such as a street number, a street name, a city, a state, a zip code, and/or a full address. In an example, each street may be partitioned into segments (e.g., of about 50, 60, 80, 100, 200, 300 or more meters long), and the geographic coordinate information 104 may include a geographic coordinate (latitude and longitude) for each of the starting location and/or ending location of a street segment. In some instances, the geographic coordinate information 104 may include a set of ordered geographic coordinates for successive street segments of a corresponding street indicated by the street address information 103, where each geographic coordinate may correspond to a starting location or an ending location of each of the successive street segments. In some instances, the street address information 103 and the corresponding geographic coordinate information 104 may be stored in the form of quantum geographic information system (QGIS) shapefiles. An example of data in the location map database 102 is shown in FIG. 3.

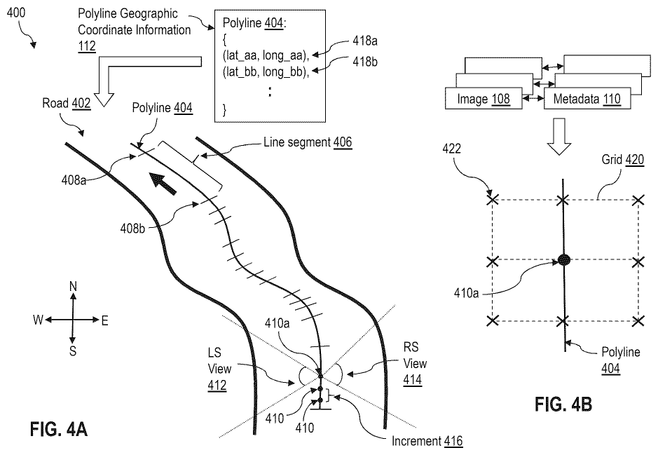

The geographic image database 106 may provide a digital representation of a real-world geographic area. The geographic image database 106 may include geographic keyed image data including polyline geographic coordinate information 112, images 108, and metadata 110. The polyline geographic coordinate information 112 may be associated with polylines representing walkable or drivable paths or routes (e.g., streets) in the real world. In some instances, a polyline may be mapped to a centerline (e.g., an asphalt centerline) of a corresponding street or roadway in the real world. A polyline is a series of connected line segments. Stated differently, a polyline may include a sequence of points connected by line segments, where each point represents a geographic location along a corresponding walkable or drivable path in the real world. In some instances, each line segment of a polyline may correspond to about 50, 100, 200, 300 or more meters in the real world. Generally, the line segments of a polyline in the geographic image database 106 may or may not have a one-to-one correspondence with street segments of a corresponding street stored in the location map database 102. The polyline geographic coordinate information 112 may store the points on a polyline in the form of a sequence of geographic coordinates, each corresponding to a respective point on the polyline. An example of a polyline and corresponding polyline geographic coordinate information 112 is shown in FIG. 4A.

The images 108 may be captured at various street locations along streets in the real-world geographic area (e.g., using cameras). In some instances, an image 108 may be captured while a vehicle equipped with camera(s) is driving down a right lane of a road (a street). In some instances, the images 108 may be obtained from videos of the streets. In an example, a drone may be used to acquire videos of the streets. In other instances, an image 108 may be captured while the vehicle is driving down a left lane of the road. That is, the images 108 may be images of street views at street locations along the streets in the real-world geographic area. In some instances, the images 108 are panoramic images providing panoramic views at respective street locations. The metadata 110 for each image 108 may include, for example, but is not limited to, a unique image identifier identifying the respective image 108 in the geographic image database 106, a geographic coordinate (e.g., latitude, longitude) of a geographic location where the respective image 108 is captured, a camera bearing used for capturing the respective image 108, and/or a timestamp indicating a date and/or time when the respective image 108 was captured. The geographic coordinate associated with an image 108 may fall on a corresponding polyline or at a vicinity of the corresponding polyline. In some instances, the metadata 110 for an image 108 may further include an association (e.g., a link or reference) between the respective image 108 and a point along a corresponding polyline that maps to a respective street location in the real-world geographic area. In some instances, the geographic image database 106 may be a Google® street view image database.

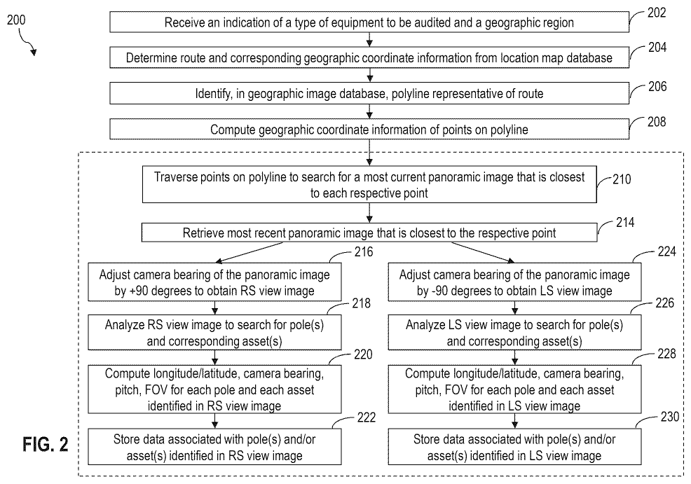

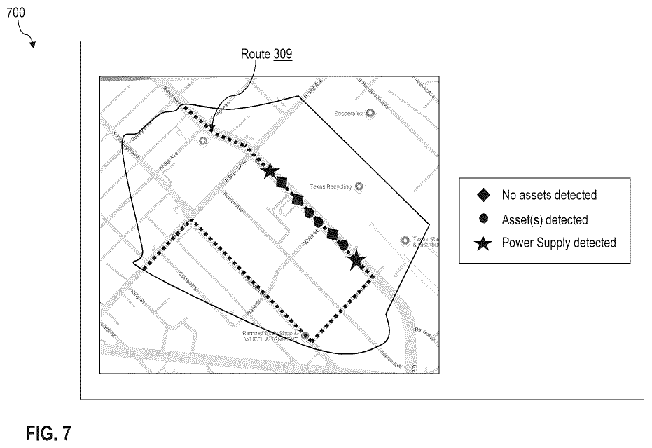

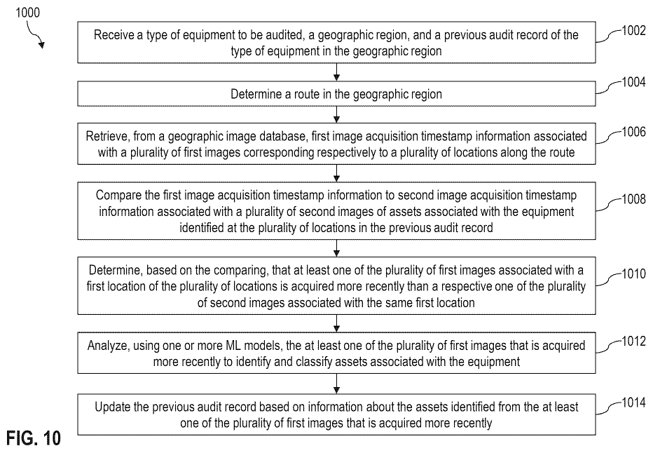

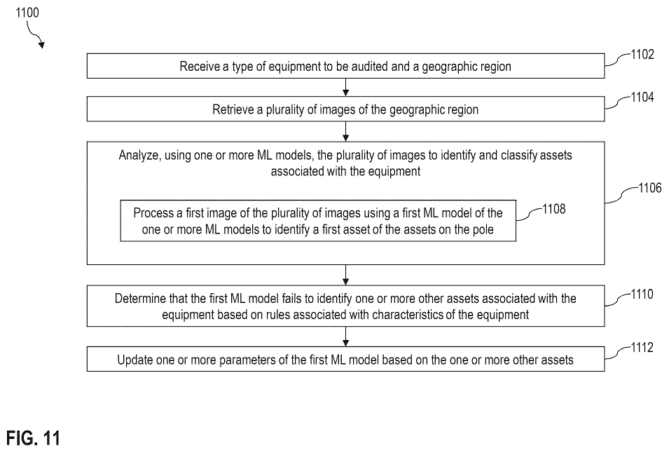

The computer system 130 may include memory and at least one processor. The computer system 130 may further include a user interface (UI) 132, a virtual audit application 134, an ML model training application 136, each comprising instructions stored at the memory and executed by the at least one processor. The virtual audit application 134 may audit infrastructure equipment (e.g., power suppliers, taps, splice enclosures, amplifiers, transformers, etc.) in a geographic region by determining a route in the geographic region based on the location map database 102 and obtaining geographic coordinate information 104 of the route from the location map database 102. The virtual audit application 134 may map the route to at least one polyline in the geographic image database 106 based on the geographic coordinate information 104 of the determined route and the polyline geographic coordinate information 112. The virtual audit application 134 may retrieve images 108 of street views along the determined route based on the polyline. The virtual audit application 134 may analyze the retrieved images 108 using one or more of the ML models 144 to identify and classify various types of assets (e.g., power suppliers, taps, splice enclosures, amplifiers, transformers, etc.) and assess a condition of each of the identified assets. The virtual audit application 134 may generate a report detailing information related to the identified assets. The virtual audit application 134 may store the report as an audit record 142 in the audit record database 140. Mechanisms for performing virtual infrastructure equipment auditing will be discussed more fully below with reference to FIGS. 2-3, 4A-4B, 5A-5E, 6, and 9-10. In some instances, the virtual audit application 134 may display information of the report graphically via the UI 132 (e.g., as shown in FIG. 7). In some instances, the UI 132 may be web-based. In some embodiments, the virtual audit application 134 may perform a subsequent audit of the same type of equipment in the same geographic region (e.g., as part of regular auditing for inventory management and/or operations assessment). As will be discussed more fully below with reference to FIG. 10, the virtual audit application 134 may perform the subsequent audit by searching for updated images 108 along the route in the geographic image database 106 and analyzing the updated images 108 instead of all images 108 along the route, thereby improving efficiency.

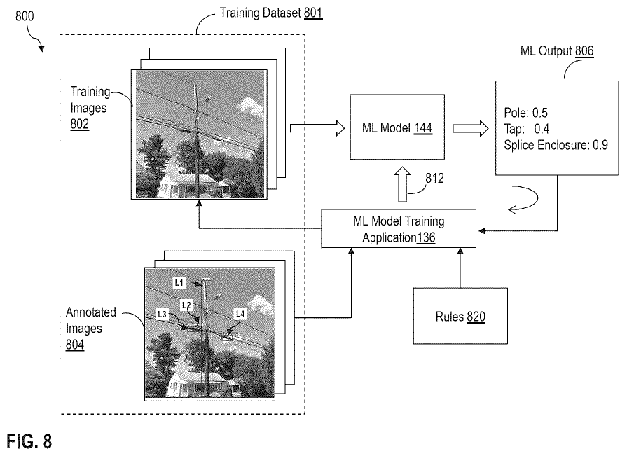

The ML model training application 136 may train an ML model 144 to perform various image analysis processing, for example, for identifying and classifying assets of various types related to infrastructure equipment from images (e.g., the images 108) as will be discussed more fully below with reference to FIGS. 8 and 11. The ML models 144 may be of any suitable transformation architectures (e.g., deep learning, convolutional neural network (CNN), super vector model (SVM), K-nearest neighbor network (KNN), etc.). In some instances, the ML model training application 136 may train an ML model 144 to perform image segmentation, for example, to enable the virtual audit application 134 to further determine geographic locations of assets identified in the images 108.

FIG. 1 is merely an example of components of a network system 100 for performing virtual infrastructure equipment auditing, and variations are contemplated to be within the scope of the present disclosure. In embodiments, the network system 100 may include other components not illustrated in FIG. 1. In embodiments, the network system 100 may not include every component illustrated in FIG. 1. In embodiments, the street geographic coordinate information 104 and corresponding street address information 103, the polyline geographic coordinate information 112, the images 108 and corresponding metadata 110 may be arranged and stored differently than those illustrated in FIG. 1. Such and other embodiments are contemplated to be within the scope of the present disclosure.

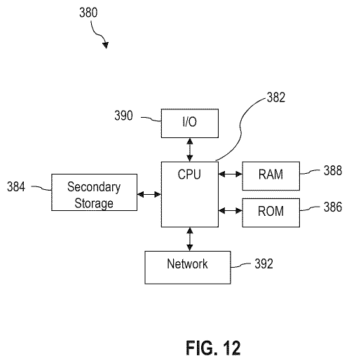

FIGS. 2-3, 4A-4B, 5A-5E, and 6-7 are discussed in relation to each other to illustrate operations for performing virtual infrastructure equipment auditing. Turning now to FIG. 2, a method 200 of performing virtual infrastructure equipment auditing using AI and computer image processing analysis is described. The method 200 may be implemented by the virtual audit application 134. In embodiments, the method 200 may be implemented using a computer system with components as shown in FIG. 12. As illustrated, FIG. 2 includes a number of enumerated operations, but embodiments of the operations in FIG. 2 may include additional operations before, after, and in between the enumerated operations. In some embodiments, one or more of the enumerated operations may be omitted or performed in a different order.

At block 202, the virtual audit application 134 may receive an indication of a type of equipment to be audited and a geographic region (e.g., the geographic region 304 shown in FIG. 3). The geographic region may be indicated by street addresses, a city, a town, a zip code, and/or a geofence (e.g., a virtual perimeter of a real-world geographic area). The type of equipment may be part of, for example, but not limited to, a utility infrastructure system, a telephony infrastructure system, or a fiber infrastructure system. The type of equipment may include, but is not limited to, a power supply, a splice enclosure, telephony equipment, a tap, an amplifier, or a transformer. At block 204, the virtual audit application 134 may determine (or look up) a route (e.g., the route 309 shown in FIG. 3) and corresponding geographic coordinate information 104 in the geographic region from the location map database 102. For instance, the geographic coordinate information 104 may include a sequence of ordered geographic coordinates (e.g., the geographic coordinates 314 shown in FIG. 3) of locations along the route. In some instances, the geographic region received at block 202 may include a list of geographic coordinates corresponding to a route where the type of equipment is to be audited. Accordingly, in such instances, the operations of block 204 may be skipped.

Turning now to FIG. 3, example location map data of the location map database 102 is described. As shown in FIG. 3, a map 302 includes a geographic region 304 (e.g., in real world) bounded by a geofence 306. The geographic region 304 may include a plurality of streets 308. For ease of illustration, FIG. 3 only shows one street with the label 308. A street 308 may be divided into a plurality of street segments 310. For ease of illustration, FIG. 3 only shows one street segment with the label 310. In some instances, the street segments 310 may have the same length (e.g., about 100 meters to 300 meters). In other instances, the street segments 310 may have variable lengths. FIG. 3 further shows a route 309 (shown by the dotted line) in the geographic region 304 for equipment auditing. The route 309 may correspond to the route determined at block 204 (for auditing the type of equipment). Generally, a route 309 for equipment auditing may include any suitable number of street segments (e.g., 1, 2, 3, 4, 5, 10, 100 or more) and/or any suitable number of streets (e.g., 1, 2, 3, 4, 5, 10, 100 or more).

In an embodiment, the location map database 102 may store street address information 103 and corresponding geographic coordinate information 104 for a street 308. The street geographic coordinate information 104 may include a series of geographic coordinates 314, each including a pair of latitude and longitude corresponding to the starting location or ending location 312 of street segments 310 of the street 308. For instance, the street geographic coordinate information 104 may include a geographic coordinate 314a of a location 312a of the street 308, a geographic coordinate 314b of a location 312b of the street 308, a geographic coordinate 314c of a location 312c of the street 308, a geographic coordinate 314d of a location 312d of the street 308, and so on. Generally, the street geographic coordinate information 104 may include a series or sequence of ordered geographic coordinates 314 corresponding to locations along a street 308.

Returning to FIG. 2, at block 206, the virtual audit application 134 may identify, in a geographic image database 106, a polyline (e.g., the polyline 404 shown in FIGS. 4A-4B) representative of the route 309 based on the geographic coordinate information 104 (e.g., the geographic coordinates 314 of the street 308) of the route 309 determined at block 204. Stated differently, the virtual audit application 134 may map the route 309 to a polyline in the geographic image database 106 based on the geographic coordinate information 104 of the determined route 309. For instance, the virtual audit application 134 may search, in the geographic image database 106 (or more specifically in the polyline geographic coordinate information 112), for a polyline with geographic coordinates (e.g., the geographic coordinates 418 shown in FIG. 4A) that are closest to the geographic coordinates 314 of the determined route 309.

At block 208, the virtual audit application 134 may compute geographic coordinate information of a plurality of points (e.g., the points 410 shown in FIG. 4A) on the polyline. For example, in some instances, the geographic coordinate information 112 (e.g., the geographic coordinates 418 shown in FIG. 4A) of the identified polyline may be sparse as discussed above. For instance, the polyline geographic coordinate information 112 may store geographic coordinates for the polyline at every 50, 100, 200, or 300 meters. However, in some cases, infrastructure equipment may be installed along the route 309 spaced apart by a shorter distance (e.g., of about 1, 2, 3, 4, 5, 10, or 20 meters). As such, the polyline geographic coordinate information 112 for the identified polyline stored in the geographic image database 106 may not have a sufficient granularity for the virtual audit application 134 to perform a virtual walk to audit the equipment.

To overcome the sparsity of the polyline geographic coordinate information 112, the virtual audit application 134 may retrieve, from the polyline geographic coordinate information 112, geographic coordinates of second points (e.g., corresponding to the markers with the label 408 shown in FIG. 4A) on the identified polyline and interpolate the retrieved geographic coordinates to compute geographic coordinates for additional points between the second points. Stated differently, the virtual audit application 134 may compute geographic coordinates of the points for traversing the polyline based on an interpolation of the retrieved geographic coordinates. At block 210, the virtual audit application 134 may traverse the plurality of points (e.g., sequentially) on the polyline to search, for each of the plurality of points, a most recent image 108 that is closest to the respective point (e.g., as shown in FIGS. 4A-4B). At block 214, the virtual audit application 134 may retrieve, for each of the plurality of points traversed on the polyline, a most recent image 108 that is closest to the respective point.

Turning now to FIGS. 4A-4B, an example method 400 of retrieving images 108 from a geographic image database 106 for virtual infrastructure equipment auditing is described. The polyline geographic coordinate information 112 of the geographic image database 106 may include information (e.g., geographic coordinates 418) associated with a polyline corresponding to the route 309 (e.g., determined at block 204). For ease of illustration, FIG. 4A illustrates only a portion of the polyline as 404. As shown, the polyline 404 may correspond to a centerline (e.g., an asphalt centerline) of a road 402 corresponding to the route 309. The polyline 404 is divided into a series of connected line segments 406 marked by markers 408a and 408b. For ease of illustration, FIG. 4A only shows one line segment with the label 406 with starting and ending points marked respectively by labels 408a and 408b.

The polyline geographic coordinate information 112 may store a series of geographic coordinates 418, each corresponding to one of a starting point or an ending point (e.g., the markers 408) of a line segment 406. In the illustrated example of FIG. 4A, the polyline geographic coordinate information 112 includes a geographic coordinate 418a, a geographic coordinate 418b respectively for the point marked by 408a and the point 408b along the polyline 404, and so on. As discussed above, because the distance or length of the line segments 406 (e.g., about 50, 100, 200, 300 or more meters) may be longer than the distance (e.g., 2, 4, 5, 10, 15, 20, or 30 meters) between equipment installed along the route 309, the virtual audit application 134 may compute additional points 410 based on an interpolation of the geographic coordinates 418 of the polyline 404 stored in the polyline geographic coordinate information 112. For ease of illustration, FIG. 4A only shows three computed points 410. Stated differently, the virtual audit application 134 may traverse the polyline 404 in increments 416 and may compute, for each increment, a geographic coordinate for a respective point 410.

To search for a most recent image 108 that is closest to a particular point 410 (e.g., the point 410a) on the polyline 404 (e.g., at block 210), the virtual audit application 134 may search, in the geographic image database 106, for images 108 in a vicinity of the point 410a. As shown in FIG. 4B, the virtual audit application 134 may overlay a grid 420 centered at about the point 410a. The virtual audit application 134 may search, in the geographic image database 106, for images 108 at the point 410a and at the intersection points 422 (shown by the symbol “X”) defined by the grid 420. For instance, the virtual audit application 134 may traverse from the point 410a on the polyline 404 to those nearby points 422 (N, S, E, W, NE, NW, SE, or SW of the point 410a) and determine whether the geographic image database 106 includes images at around those points 422. For ease of illustrations, FIG. 4B only shows one of the intersection points with the label 422. In the illustrated example of FIG. 4B, the grid 420 is a 3-by-3 grid. In an example, the grid 420 may have a dimension of about 6 feet by 6 feet, 8 feet by 8 feet, or 10 feet by 10 feet. Generally, the virtual audit application 134 may use a grid of any suitable granularity (e.g., a 2-by-2 grid, a 4-by-4 grid, etc.) and any suitable dimensions.

In an embodiment, as part of searching for the most recently acquired image 108 closest to the point 410a (along the polyline 404) at block 210, the virtual audit application 134 may retrieve, from the geographic image database 106 (or more specifically the metadata 110), timestamp information (e.g., image acquisition dates and/or times) of images 108 of the point 410a on the polyline 404 and/or multiple neighboring points 422 proximal to the point 410a and compare the timestamp information to select the image 108 with the most recent timestamp from those images 108.

As discussed above, the metadata 110 for a respective image 108 in the geographic image database 106 may include an image identifier and a timestamp for the respective image 108. Accordingly, in some instances, as part of searching for the most recent image 108 that is closest to the point 410a, the virtual audit application 134 may search the metadata 110 associated with the point 410a and the nearby points 422 for an image identifier that is associated with a most current timestamp. After finding the image identifier associated with the most current timestamp, the virtual audit application 134 may retrieve the image 108 identified by that image identifier (associated with the most recent timestamp).

Returning to FIG. 2, after retrieving the images from the geographic image database, the virtual audit application 134 may analyze the retrieved images 108 using one or more ML models 144 trained to identify and classify assets (e.g., poles and attachments on the poles) associated with the equipment and assess a condition of each of the identified assets. As discussed above, the images 108 may be panoramic images of street views at corresponding locations along the route 309. Accordingly, as part of analyzing the images 108, the virtual audit application 134 may apply, to each retrieved image (corresponding to a respective location along the polyline), a first camera bearing adjustment (e.g.,−90 degrees) to obtain a left-side (LS) view image (e.g., at block 216) and a second camera bearing adjustment (e.g., +90 degrees) to obtain a right-side (RS) view image (e.g., at block 224). The virtual audit application may further optimize views of those LS view and RS view images for use by the one or more ML models 144 to identify and classify the assets associated with the equipment in those LS view images and/or RS view images.

Returning to FIG. 4A, when the virtual audit application 134 is at the point 410a traversing towards a direction pointing to the N, the virtual audit application 134 may retrieve (from the geographic image database 106) a panoramic image 108 with a camera bearing of 0 degrees (corresponding to N). When the virtual audit application 134 adjusts the camera bearing of the panoramic image 108 by +90 degrees, the resulting image may provide a RS view 414 at the point 410a (e.g., pointing to the E). When the virtual audit application 134 adjusts the camera bearing of the panoramic image 108 by−90 degrees, the resulting image may provide a LS view 412 at the point 410a (e.g., pointing to the W). As another example, when the virtual audit application 134 is traversing a polyline 404 towards a direction of the E, the virtual audit application 134 may adjust the camera bearing of a panoramic image 108 along the polyline 404 by +90 degrees to obtain a RS view pointing to the S or adjust the camera bearing of the panoramic image 108 by −90 degrees to obtain a LS view pointing to the N.

Returning to FIG. 2, at block 218, after obtaining the RS view image for a respective point 410 on the polyline 404, the virtual audit application 134 may analyze the RS view image to search for pole(s) and corresponding asset(s) in the RS view image. Similarly, at block 226, after obtaining the LS view image for a respective point 410 on the polyline 404, the virtual audit application 134 may analyze the LS view image to search for pole(s) and corresponding asset(s) in the LS view image. As part of the analysis, the virtual audit application 134 may further adjust and optimize views of those LS view image and RS view image for use by the one or more ML models 144. For instance, the virtual audit application 134 may analyze each of those LS view image and RS view image by applying a series of image view adjustments (e.g., camera bearing adjustments, pitch adjustment, and/or FOV adjustments) interleaved with ML processing.

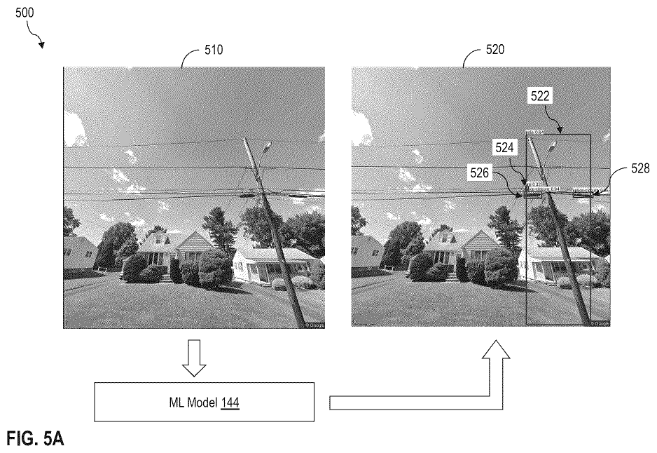

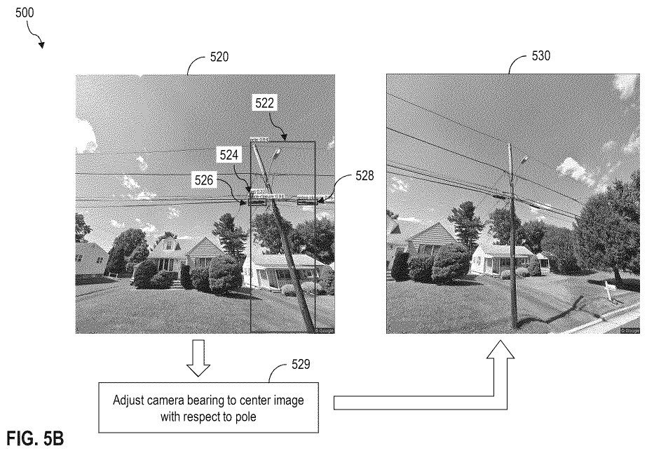

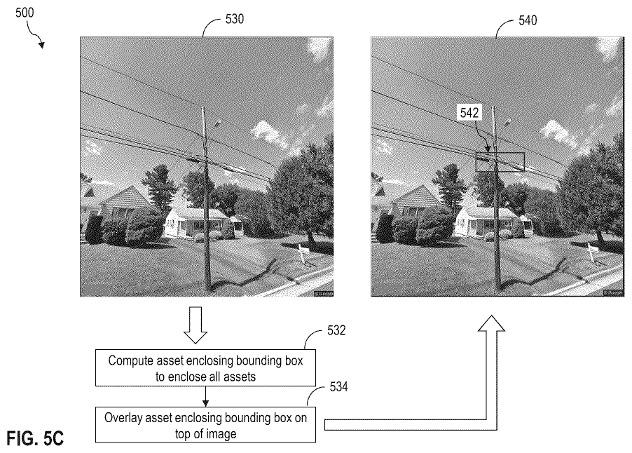

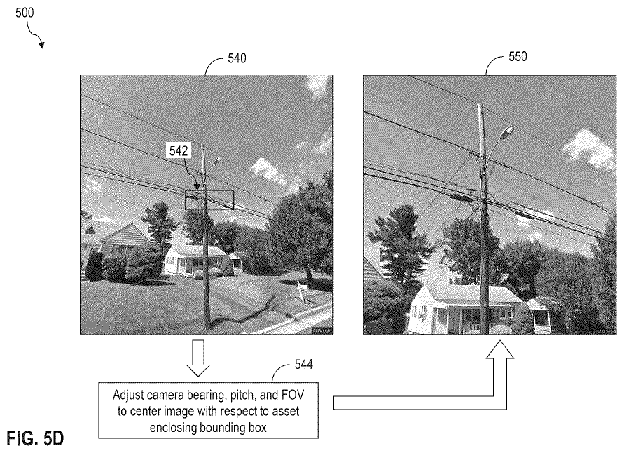

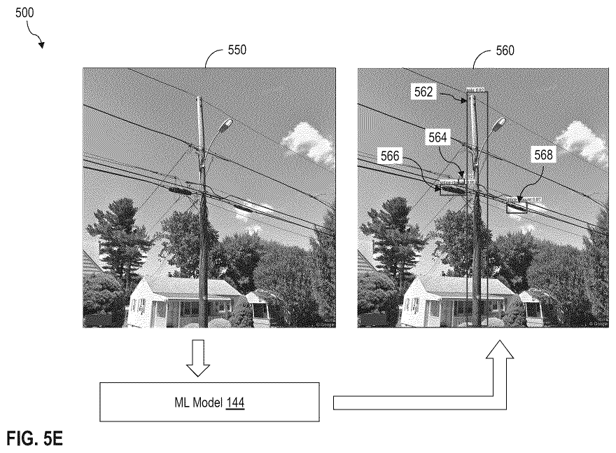

In an embodiment, the virtual audit application 134 may process an image (e.g., a LS view image or a RS view image) using an ML model 144 and determine whether an asset of the equipment is identified and whether the result (e.g., the confidence score of the identified asset, the view of the identified asset, the image quality, etc.) is satisfactory based on one or more criteria. For instance, the virtual audit application 134 may determine whether the confidence score of the identified asset meets a certain threshold. The virtual audit application 134 may also determine whether the identified asset is at about the center of the image. If the result is unsatisfactory, the virtual audit application 134 may adjust a camera bearing and/or an FOV of the image (e.g., to center the image) based on the output of the ML model 144 and repeat the ML processing. The operations of ML processing and camera bearing and/or FOV adjustments may be repeated until a satisfactory result is obtained (e.g., as shown in FIGS. 5A-5E). Generally, the virtual audit application 134 may apply various image processing techniques (e.g., contrast enhancement, noise reduction, color correction, image resizing, resolution enhancement, equalization, filtering, etc.) to improve the quality of an image 108 prior to applying ML processing to identify the assets.

Turning now to FIGS. 5A-5E, an example method 500 of processing images using AI and computer image processing and analysis for virtual infrastructure equipment auditing is described. The method 500 may begin after the virtual audit application 134 retrieves an image 108 (a panoramic image) from the geographic image database 102 for a particular point 410 along the polyline 404 and adjusts a camera bearing of the retrieved image 108 to obtain a LS view image or a RS view image using mechanisms discussed above with reference to FIGS. 1-3 and 4A-4B. In the method 500, the virtual audit application 134 may analyze a LS view image or a RS view image using a series of ML processing and image view adjustments (e.g., camera bearing, pitch, and/or FOV adjustments).

For instance, in FIG. 5A, the virtual audit application 134 may provide an image 510 (the LS view image or the RS view image) as an input to the ML model 144 (trained to identify objects associated with the infrastructure equipment under auditing). The ML model 144 may process the image 510 and output identified objects and corresponding confidence scores (e.g., a value between 0 and 1) for the identified objects. As shown in FIG. 5A, the ML model 144 may output bounding boxes 522, 524, 526, and 528, each enclosing an identified object with a classification for the identified object and a corresponding confidence score. For instance, the output of the ML model 144 may indicate that the identified object in the bounding box 522 is a pole with a confidence score of 0.84. The output of the ML model 144 may further indicate that the identified object in the bounding box 524 is a tap with a confidence score of 0.32. The output of the ML model 144 may further indicate that the identified object in the bounding box 526 is a splice enclosure with a confidence score of 0.54. The output of the ML model 144 may further indicate that the identified object in the bounding box 528 is a splice enclosure with a confidence score of 0.55. The image 520 may correspond to the image 510 with the ML model 144 output information overlaid on top of the image 510. The virtual audit application 134 may determine that the confidence score for the pole is satisfactory (e.g., meeting a certain threshold), and thus may record information associated with the pole. The recorded information may include coordinates of the bounding box 522 enclosing the pole, the classification being a pole, and the corresponding confidence score of 0.84. The virtual audit application 134 may further determine that the confidence scores for the tap and splice enclosures are unsatisfactory (e.g., below than a certain threshold), and thus may further optimize the view of the image before subsequent analysis (e.g., as shown by FIGS. 5B-5D).

Turning now to FIG. 5B, at operation 529, after processing the image 510 using the ML model 144, the virtual audit application 134 may adjust the camera bearing and the FOV of the image 520 to center the image 520 at the pole (e.g., zoom into the image portion with the pole). As shown, the camera bearing and FOV adjustment may generate an image 530 that is centered with respect to the pole (or more specifically, centered with respect to the bounding box 522 enclosing the identified pole).

Turning now to FIG. 5C, at operation 532, after generating the camera bearing adjusted image 530 centered at the pole, the virtual audit application 134 may compute an asset enclosing bounding box 542 enclosing all assets (the tap and splice enclosures attached to the pole) previously identified in the image 530. The virtual audit application 134 may compute the asset enclosing bounding box 542 based on the bounding boxes 524, 526, and 528 output by the ML model 144 shown in FIGS. 5A and 5B. More specifically, the asset enclosing bounding box 542 are calculated mathematically and are represented in terms of the physical pixel positions in the image 530. Further, the virtual audit application 134 may mathematically determine that the physical pixels of the bounding box 542 are not in the center of the image 530, and thus may proceed to center the image 530 at the bounding box 542 in operations 534 and 544. At operation 534, the virtual audit application 134 may overlay the asset enclosing bounding box on top of the image 530. The resulting image is shown by the image 540 and the computed asset enclosing bounding box is shown by 542.

Turning now to FIG. 5D, at operation 544, after computing the asset enclosing bounding box 542, the virtual audit application 134 may adjust the camera bearing, the pitch, and the FOV of the image 540 to center the image 540 at the asset enclosing bounding box 542 (e.g., zoom into the image portion with the assets to provide a better view for subsequent analysis). As shown, the camera bearing adjustment may generate an image 550 that is centered with respect to the asset enclosing bounding box 542.

Turning now to FIG. 5E, after generating the image 550 centering at the asset enclosing bounding box 542, the virtual audit application 134 may further process the image 550 using the ML model 144. The ML model 144 may output bounding boxes 562, 564, 566, and 568, each enclosing an identified object with a classification for the identified object and a corresponding confidence score. For instance, the output of the ML model 144 may indicate that the identified object in the bounding box 562 is a pole with a confidence score of 0.82. The output of the ML model 144 may indicate that the identified object in the bounding box 564 is a tap with a confidence score of 0.92. The output of the ML model 144 may indicate that the identified object in the bounding box 566 is a splice enclosure with a confidence score of 0.95. The output of the ML model 144 may indicate that the identified object in the bounding box 568 is also a splice enclosure with a confidence score of 0.97. The image 560 may correspond to the image 550 with the ML model 144 output information overlaid on top of the image 560.

The virtual audit application 134 may determine that the confidence scores for each of the tap and the splice enclosures is satisfactory (e.g., meeting a certain threshold), and thus may record information associated with the identified tap and splice disclosures. The recorded information may include coordinates of the bounding box 564 enclosing the tap, the classification being a tap, and the corresponding confidence score of 0.92. The recorded information may further include the coordinates of the bounding box 566 enclosing the splice enclosure, the classification being a splice enclosure, and the corresponding confidence score of 0.95. The recorded information may further include the coordinates of the bounding box 568 enclosing the other splice enclosure, the classification being a splice enclosure, and the corresponding confidence score of 0.97.

Returning to FIG. 2, at block 220, after the virtual audit application 134 completed analyzing the RS view image (e.g., using the method 500), the virtual audit application 134 may compute geographic coordinate information (e.g., latitude and longitude), a camera bearing, a pitch, an FOV for each pole and/or each asset identified in the RS view image. At block 222, the virtual audit application 134 may store data associated with each pole and/or each asset found in the RS view image. The data may include information computed at block 220 and at least some of the metadata 110 associated with the image 108 from which the RS view image is generated. In a similar way, at block 228, after the virtual audit application 134 completed analyzing the LS view image (e.g., using the method 500), the virtual audit application 134 may compute geographic coordinate information (e.g., latitude and longitude), a camera bearing, a pitch, an FOV for each pole and/or each asset identified in the LS view image. At block 230, the virtual audit application 134 may store data associated with each pole and/or each asset found in the LS view image. The data may include information computed at block 228 and at least some of the metadata 110 associated with the image 108 from which the LS view image is generated.

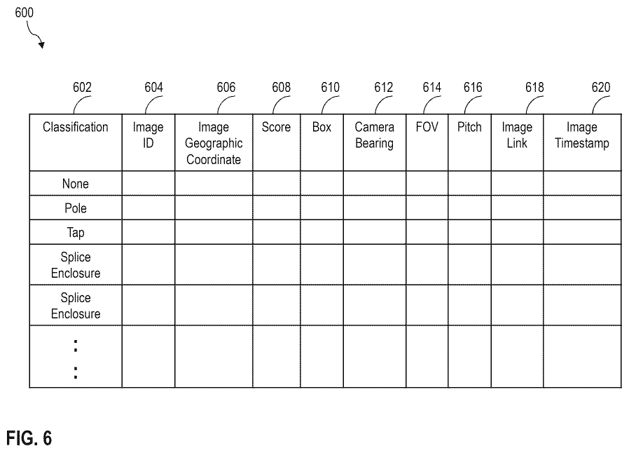

Subsequently, the virtual audit application 134 may generate a report detailing all the identified assets (e.g., the tap, the splice enclosures, etc.) and identified poles carrying those identified assets within the defined geographic region 304. The report may include location information, asset type information, asset count information, and/or one or more links to images (e.g., as shown in FIG. 6).

Turning now to FIG. 6, example data 600 generated from virtual infrastructure equipment auditing is described. For instance, the data 600 may be generated by the virtual audit application 134 performing virtual auditing of infrastructure equipment as discussed above. As shown in FIG. 6, the data 600 may include a classification 602 (e.g., an asset type) of each identified asset and a corresponding confidence score 608 (output by an ML model 144), an image identifier 604 (e.g., a unique image identifier, “Image ID”, etc.) identifying a respective one of the images 108 in which the respective asset is identified, a geographic coordinate (shown by image geographic coordinate 606) associated with the respective image 108, an image acquisition timestamp 620 (when the respective image 108 was captured), coordinates of a bounding box (shown by 610) that encloses the respective identified asset (output by the second ML model 144), a camera bearing 612 associated with the respective identified asset, an FOV 614 associated with the respective identified asset, a pitch 616 associated with the respective identified asset, an image path 618 linking or referencing an image of the respective identified asset (e.g., the image 560 of FIG. 5E for visual verification and/or further analysis), and an image timestamp 620 (indicating a date and/or time when the respective image 108 was captured). In some instances, the data 600 may also include a link (e.g., a web link) to the respective image 108 in the geographic image database 106. In some instances, when the virtual audit application 134 applies image segmentation as part of the analysis, the data 600 may include a geographic coordinate of a location of the respective identified asset.

Some of the data 600, such as the image identifier 604, the image geographic coordinate 606, and the timestamp 620, may be obtained from the geographic image database 106. Some of the data 600, such as the confidence score 608, the coordinates of the bounding box 610, the camera bearing 612, the FOV 614, and the pitch 616, may be computed by the virtual audit application 134 as part of the image analysis (e.g., operations at blocks 216 to 230 of FIG. 2). The data 600 may further include similar information for each identified pole carrying respective identified assets. In some examples, the virtual audit application 134 may not identify any pole and/or asset associated with the equipment in a certain image 108 along the auditing route 309. In such examples, the virtual audit application 134 may include, in the data 600, an indication of “None” in the classification 602 for that image 108 (e.g., as shown in the first row of the data 600).

In some examples, the virtual audit application 134 may store the data 600 in a tabulated format as shown in FIG. 6. In some examples, the virtual audit application 134 may store the data 600 in a spreadsheet format. In some examples, the virtual audit application 134 may store the data 600 in a comma-separate-value (csv) format. Generally, the virtual audit application 134 may store the data 600 in any suitable format. In some instances, the virtual audit application 134 may store the data 600 as an audit record 142 in the audit record database 140. The virtual audit application 134 may also display the report including the data 600 in various ways. For instance, the report may be provided via a web-based dashboard. In some instances, the virtual audit application 134 may provide a graphical view of at least some information of the report via the UI 132.

Turning now to FIG. 7, an example graphical view 700 of a virtual infrastructure equipment auditing result is described. In an embodiment, the graphical view 700 may be provided via the UI 132. As shown in FIG. 7, the graphical view 700 includes the route 309 walked by the virtual audit application 134 for equipment auditing (e.g., as discussed above with reference to FIGS. 1-3, 4A-4B, 5A-5E, and 6). For ease of illustration, FIG. 7 only shows the audit result for a portion of the route 309. As shown, the graphical view 700 includes indications of locations along the route 309 where no asset was detected (shown by the diamond-shaped markers), indications of locations along the route 309 where one or more assets (e.g., taps, splice enclosures, amplifiers, transformers, etc.) were detected (shown by the circle markers), and indications of locations along the route 309 where a power supply was detected (shown by the star-shaped markers). Generally, the virtual audit application 134 may indicate the detected assets using any markers and may use different markers for different types of assets. In some instances, the virtual audit application 134 may display the graphical view 700 using quantum geographic information system (QGIS) system software to provide visualized validation at a map level and/or at a virtual audit result field level (e.g., the data 600 of FIG. 6). While FIG. 7 only illustrates assets identified along the route 309 (along a street), the virtual audit application 134 discussed herein may be applicable for identifying assets at any suitable location (e.g., including off-street locations).

After the virtual audit application 134 generated the report (e.g., including the data 600), the virtual audit application 134 may take various actions based on the generated report. In an embodiment, the virtual audit application 134 may cross-correlate the information in the report with a company's internal audit records. For instance, a utility company requesting the audit may provide an internal audit record 142 of utility equipment. In an embodiment, the virtual audit application 134 may update audit records 142 (in the audit record database 140) based on the report and recommend infrastructure changes to promote greater efficiency (in terms of cost savings and/or resource/energy consumption savings). In an embodiment, the virtual audit application 134 may promote enhanced security by uncovering vulnerabilities in outdated systems and enable actions to address security risks. In an embodiment, the virtual audit application 134 may further assess the conditions of the identified assets (e.g., whether an identified asset is connected or disconnected, active or inactive, etc.). For instance, the virtual audit application 134 may identify decommissioned equipment based on an identified asset being disconnected from a power line.

Turning now to FIG. 8, a method 800 of training an ML model 144 for virtual infrastructure equipment auditing is described. The method 800 may be implemented by the ML model training application 136. The ML model training application 136 may train the ML model 144 using a training data set 801 including training images 802 and corresponding annotated images 804. The training images 802 may be images of street views captured in the real world along walkable or drivable paths or routes. The training images 802 may include assets associated with the infrastructure equipment attached to poles and/or ground-based infrastructure equipment located along the paths. Each training image 802 may have a corresponding annotated image 804. The corresponding annotated image 804 be the same as the respective image 802 and may further include bounding boxes enclosing respective assets and poles and corresponding labels (e.g., shown by L1, L2, L3, and L4). For instance, the label L1 may include text indicating “pole”, the label L2 may include text indicating “tap”, the label L3 may include text indicating “splice enclosure”, and the label L4 may include text indicating “splice enclosure”. To improve the accuracy of the ML model 144, the training images 802 may be captured under different lighting conditions (e.g., different hours of the day), different weather conditions (e.g., sunny, foggy, rain, snow, etc.), different seasons (e.g., spring, summer, autumn, and spring), using different models of cameras, in different geographic areas (e.g., different towns, different cities, areas with different landscapes, different vegetations, different building structures, etc.).

The ML model training application 136 may input each training image 802 to the ML model 144. The ML model 144 may process the training image 802 to generate ML output 806. The ML output 806 may include identified objects associated with the infrastructure equipment (e.g., a pole, a tap, and/or a splice enclosure) and corresponding confidence scores 608. The ML model training application 136 may evaluate the ML output 806. For instance, the ML model training application 136 may compare the ML output 806 with the ground truths (e.g., corresponding annotated images 804) to determine an error (e.g., based on a loss function). The ML model training application 136 may update parameters of the ML model 144 based on the error as shown by the arrow 812. The process of inputting the training image 802 to the ML model 144, comparing the output of the ML model 144 with the ground truth, and updating the parameters of the ML model 144 may be repeated until the error is satisfactory (e.g., below a certain threshold). The ML model training application 136 may also repeat the process stepping through all the training images 802 in the training data set 801.

The ML models 144 may generally have any suitable architectures. In an example, the ML model 144 may include a plurality of layers, for example, an input layer, followed by one or more hidden layers and an output layer. Each layer may include a set of weights and/or biases that can transform inputs received from a previous layer and the resulting outputs can be passed to the next layer. The weights and/or biases in each layer can be trained and adapted, for example, to classify objects including poles and assets associated with particular type of infrastructure equipment. The training of the ML model 144 may be based on a backpropagation process. The backpropagation process may perform a backward pass through the layers in the ML model 144 while adjusting the weights and/or biases at each layer.

In some instances, the ML model training application 136 may apply additional rules 820 to evaluate the ML model output 806. The rules 820 may be associated with characteristics of the infrastructure equipment. As an example, when the infrastructure equipment is utility equipment, the characteristics may be specific to utility equipment. As another example, when the infrastructure equipment is cable or optic fiber equipment, the characteristics may be specific to cable or optic fiber equipment. The characteristics may be observed from the installation layout, arrangement, or connections of the equipment and/or operations of the equipment. In some instances, the rules 820 may include an indication of a coexistence between a first type of asset and a second type of asset for the infrastructure equipment. That is, if the ML model 144 identifies an asset of the first type in an image (e.g., an image 510 or 550) but not an asset of the second type, the ML model training application 136 may determine that the ML model 144 missed identifying the asset of the second type. As an example, if a transmission wire and a fuse cutout are attached to a pole, then there has to be a tap connected in parallel with the transmission wire. In some instances, the rules 820 may specify steps for further training the ML model 144. As an example, if an asset is identified from an image 802 by the ML model 144 but with a low confidence score, that image is secondarily reviewed (e.g., based on the rules 820). If the asset is positively confirmed as the asset type identified in the initial analysis, the asset is recaptured and used for additional training. For instance, the ML model 144 may identify a utility pole in an image 802 but with a low confidence score of 60%. That image 802 is reviewed a second time. If the second review determines that the asset is a utility pole with a high confidence or certainty, that initial image 802 is used for further training of the ML model 144 to capture the variables that resulted in the low confidence score. In some instances, the rules 820 may include a comparison of assets identified by the ML model 144 to an external data source (e.g., a company's internal record). Generally, the rules 820 may be implemented as software processing logics to be applied to the inference output of the ML model 144 to determine missing assets and to initiate further training of the ML model 144.

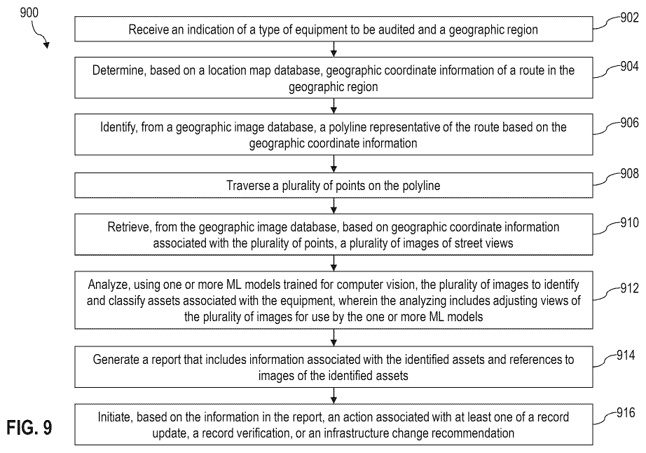

Turning now to FIG. 9, a method 900 is described. In an embodiment, the method 900 is a method of performing virtual infrastructure equipment auditing. The method 900 may be implemented by the virtual audit application 134. The method 900 may include similar mechanisms as discussed above with reference to FIGS. 1-3, 4A-4B, 5A-5E, and 6-7. In embodiments, the method 900 may be implemented using a computer system with components as shown in FIG. 12. As illustrated, FIG. 9 includes a number of enumerated operations, but embodiments of the operations in FIG. 9 may include additional operations before, after, and in between the enumerated operations. In some embodiments, one or more of the enumerated operations may be omitted or performed in a different order.

At block 902, the virtual audit application 134 receives an indication of a type of equipment to be audited and a geographic region 304. At block 904, the virtual audit application 134 determines, based on a location map database 102, geographic coordinate information 104 (e.g., the geographic coordinates 314) of a route 309 in the geographic region 304. At block 906, the virtual audit application 134 identifies, from a geographic image database 106, a polyline 404 representative of the route 309 based on the geographic coordinate information 104. At block 908, the virtual audit application 134 traverses a plurality of points (e.g., the points 408 and/or 410) on the polyline 404.

At block 910, the virtual audit application 134 retrieves, from the geographic image database 106, based on geographic coordinate information 112 associated with the plurality of points 410, a plurality of images 108 of street views, each associated with a respective one of the plurality of points 410. In an embodiment, as part of the retrieving the plurality of images 108, the virtual audit application 134 searches the geographic image database 102, for a most recent image 108 in a proximity of an individual point (e.g., the point 410a) of the plurality of points. In an embodiment, as part of the searching, the virtual audit application 134 retrieves, from the geographic image database 106, timestamp information (e.g., metadata 110) of images 108 associated with a plurality of neighboring points (e.g., the points 422) proximal to the individual point 410a on the polyline 404. Further, the virtual audit application 134 compares the timestamp information of the images 108 associated with the plurality of neighboring points to select the most recent image 108 in the proximity of the individual point 410a. In an embodiment, the plurality of neighboring points in the proximity of the individual point 410 are based on intersection points 422 of a grid 420 overlaid on the individual point 410a.

At block 912, the virtual audit application 134 analyzes, using one or more ML models 144 trained for image analysis, the plurality of images 108 to identify and classify assets (e.g., a power supply, a splice enclosure, telephony equipment, a tap, an amplifier, and/or a transformer) associated with the equipment. The analyzing includes adjusting views of the plurality of images 108 for use by the one or more ML models 144 (e.g., as discussed above with reference to FIGS. 5A-5E). For instance, as part of adjusting the views of the plurality of images 108, the virtual audit application 134 adjusts at least one of a camera bearing or an FOV of an individual image 108 of the plurality of images 108 to generate a first adjusted image (e.g., the images 510, 530, and/or 540). Further, as part of analyzing the plurality of images 108, the virtual audit application 134 processes the first adjusted image using a first ML model 144 of the ML models 144 to identify at least one of one or more assets of the assets or a pole associated with the equipment in the first adjusted image.

In a further embodiment, as part of adjusting the views of the plurality of images 108, the virtual audit application 134 adjusts a least one of a camera bearing or an FOV of the first adjusted image based on the at least one of one or more assets or the pole identified by the first ML model 144 to generate a second adjusted image (e.g., the image 530 and/or 540). Further, as part of analyzing the plurality of images 108, the virtual audit application 134 further processes the second adjusted image using a second ML model 144 of the ML models 144 to identify the one or more assets in the second adjusted image. In some instances, the first ML model 144 may be the same as the first ML model 144. In other instances, the first ML model 144 may be different than the second ML model 144.

In another further embodiment, as part of adjusting the views of the plurality of images 108, the virtual audit application 134 adjusts the camera bearing of the individual image 108 to generate the first adjusted image to provide a left-side (LS) view or a right-side (RS) view with respect to a respective one of the plurality of points 410 along the polyline 404. The virtual audit application 134 further adjusts at least one of a camera bearing or an FOV of the first adjusted image with respect to the identified pole to generate a second adjusted image (e.g., the image 530 discussed above with reference to FIG. 5B), where the identified pole is at about a center of the second adjusted image. The virtual audit application 134 further computes, based on the second adjusted image, an asset enclosing bounding box 542 to enclose all the one or more assets in the second adjusted image (e.g., as discussed above with reference to FIG. 5C). The virtual audit application 134 further adjusts at least one of a camera bearing, a pitch, or an FOV of the second adjusted image with respect to the asset enclosing bounding box to generate a third adjusted image (e.g., the image 540 discussed above with reference to FIG. 5D). Further, as part of analyzing the plurality of images 108, the virtual audit application 134 further processes the third adjusted image, using a second ML model 144 of the one or more ML models 144, to output an indication of the one or more assets in the third adjusted image and a classification of each of the one or more assets (e.g., as discussed above with reference to FIG. 5E).

In some embodiments, the analyzing the plurality of images 108 may further include assessing a condition of each of the identified assets. For instance, the virtual audit application 134 may determine whether an identified asset is connected or disconnected (e.g., based on connections associated with the identified asset captured in the respective image). The virtual audit application 134 may also determine whether an identified asset is out of date and may require an upgrade (e.g., based on a configuration of the identified asset captured in the respective image).

At block 914, the virtual audit application 134 generates a report that includes information associated with the identified assets and references to images (e.g., the images 550 and/or 560) of the identified assets. In some instances, the references to the images may be in the form of a storage path (e.g., a web link) to the images of the identified assets. In other instances, the report may include the images of the identified assets and the references may refer to the images within the report. In an embodiment, the information associated with identified assets in the report includes, for each of the identified assets, at least one of a classification 602 and a corresponding confidence score 608 for the respective identified asset, geographic coordinate information (e.g., the image geographic coordinate 606) associated with the respective identified asset, a camera bearing 612 associated with the respective identified asset, an FOV 614 associated with the respective identified asset, or a pitch 616 associated with the respective identified asset (e.g., the data 600 shown in FIG. 6).

At block 916, the virtual audit application 134 initiates, based on the information in the report, an action associated with at least one of a record update, a record verification, or an infrastructure change recommendation. In some instances, the record update may include updating an audit record 142 in the audit record database 140 based on the information in the report. In some instances, the record verification may include cross-correlating the information in the report with an audit record 142 (e.g., a company's internal audit records) stored in the audit record database 140. In some instances, the infrastructure change recommendation may include removing a certain outdated, decommissioned, or disconnected equipment (that is no longer in use) for billing purposes and/or physically removing the outdated, decommissioned, or disconnected equipment. In some instances, the infrastructure change recommendation may include installing additional infrastructure equipment to improve operational efficiency. In some instances, the infrastructure change recommendation may include replacing a certain outdated infrastructure equipment with more secure infrastructure equipment (e.g., with more advanced security features).

In an embodiment, the virtual audit application 134 further retrieves, from the geographic image database 106, second geographic coordinate information (e.g., the geographic coordinates 418) of a plurality of second points 408 on the polyline 404. The virtual audit application 134 further computes the geographic coordinate information of at least some of the plurality of points 410 on the polyline 404 for the traversing at block 908 based on an interpolation of the second geographic coordinate information of the plurality of second points.

Turning now to FIG. 10, a method 1000 is described. In an embodiment, the method 1000 is a method of performing subsequent virtual infrastructure equipment auditing (e.g., after performing an infrastructure audit using the method 900). The method 1000 may be implemented by the virtual audit application 134. The method 1000 may include similar mechanisms as discussed above with reference to FIGS. 1-3, 4A-4B, 5A-5E, and 6-7 and 9. In embodiments, the method 1000 may be implemented using a computer system with components as shown in FIG. 12. As illustrated, FIG. 10 includes a number of enumerated operations, but embodiments of the operations in FIG. 10 may include additional operations before, after, and in between the enumerated operations. In some embodiments, one or more of the enumerated operations may be omitted or performed in a different order.

At block 1002, the virtual audit application 134 receives a type of equipment to be audited, a geographic region 304, and a previous audit record 142 of the type of equipment in the geographic region 304. At block 1004, the virtual audit application 134 determines a route 309 in the geographic region 304.

At block 1006, the virtual audit application 134 retrieves, from a geographic image database 106, first image acquisition timestamp information (e.g., the metadata 110) associated with a plurality of first images 108 corresponding respectively to a plurality of locations along the route 309 (e.g., the points 410 and/or 408 along the polyline 404). In an embodiment, as part of the retrieving the first image acquisition timestamp information, the virtual audit application 134 searches, the geographic image database 106, for each location of the plurality of locations, for a timestamp associated with a most recent image 108 that is closest to the respective location (e.g., using mechanisms discussed above with reference to FIGS. 4A-4B).

At block 1008, the virtual audit application 134 compares the first image acquisition timestamp information retrieved from the geographic image database 106 to second image acquisition timestamp information associated with a plurality of second images 108 of assets associated with the equipment identified at the plurality of locations in the previous audit record 142.

At block 1010, the virtual audit application 134 determines, based on the comparing, that at least one of the plurality of first images 108 associated with a first location of the plurality of locations is acquired more recently than a respective one of the plurality of second images 108 associated with the same first location.

At block 1012, the virtual audit application 134 analyzes, using one or more ML models 144 trained for image analysis, the at least one of the plurality of first images 108 that is acquired more recently to identify and classify assets associated with the equipment. In an embodiment, the assets comprise at least one of a power supply, a splice enclosure, telephony equipment, a tap, an amplifier, or a transformer. In an embodiment, the virtual audit application 134 may adjust views of the first images 108 for use by the first ML model 144. For instance, the first images 108 may be a panoramic image, and the virtual audit application 134 may adjust a camera bearing of the at least one first image 108 to obtain a LS view image or a RS view image (e.g., as discussed above with reference to FIG. 2). The virtual audit application 134 may analyze the LS view image or a RS view image by applying a series of camera bearing, pitch, and/or FOV adjustments interleaved with processing by the first ML model 144 (e.g., as discussed above with reference to FIGS. 5A-5E).

At block 1014, the virtual audit application 134 updates the previous audit record 142 based on information about the assets identified from the at least one of the plurality of first images 108 that is acquired more recently.

Turning now to FIG. 11, a method 1100 is described. In an embodiment, the method 1100 is a method of evaluating and updating an ML model 144 for virtual auditing of infrastructure equipment based on rules associated with characteristics of the infrastructure equipment (e.g., during an inference stage of the trained ML model 144). The method 1100 may be implemented by the virtual audit application 134 and the ML model training application 136. The method 1100 may include similar mechanisms as discussed above with reference to FIGS. 1-3, 4A-4B, 5A-5E, and 6-10. In embodiments, the method 1100 may be implemented using a computer system with components as shown in FIG. 12. As illustrated, FIG. 11 includes a number of enumerated operations, but embodiments of the operations in FIG. 11 may include additional operations before, after, and in between the enumerated operations. In some embodiments, one or more of the enumerated operations may be omitted or performed in a different order.

At block 1102, the virtual audit application 134 receives a type of equipment to be audited and a geographic region 304. At block 1104, the virtual audit application 134 retrieves a plurality of images 108 of the geographic region 304 (e.g., from a geographic image database 106 as discussed above with reference to FIGS. 2, 3, and 4A-4B).

At block 1106, the virtual audit application 134 analyzes, using one or more ML models 144, the plurality of images 108 to identify and classify assets associated with the equipment. At block 1108, as part of the analyzing, the virtual audit application 134 processes a first image 108 of the plurality of images 108 using a first ML model 144 of the one or more ML models 144 to identify a first asset of the assets. In an embodiment, the virtual audit application 134 may adjust views of the first image 108 for use by the first ML model 144. For instance, the first image 108 may be a panoramic image, and the virtual audit application 134 may adjust a camera bearing of the first image 108 to obtain a LS view image or a RS view image (e.g., as discussed above with reference to FIG. 2). The virtual audit application 134 may analyze the LS view image or a RS view image by applying a series of camera bearing, pitch, and/or FOV adjustments interleaved with processing by the first ML model 144 (e.g., as discussed above with reference to FIGS. 5A-5E).

At block 1110, the ML model training application 136 determines that the first ML model 144 fails to identify one or more other assets associated with the equipment based on rules 820 associated with characteristics of the equipment. In an embodiment, the rules 820 include an indication of a coexistence between a first type of assets and a second type of assets for the equipment. Additionally or alternatively, the rules 820 include a comparison against an external data source having records 142 of assets associated with the equipment. In an embodiment, the one or more other assets determined based on the rules 820 includes at least one of a power supply, a splice enclosure, telephony equipment, a tap, an amplifier, or a transformer.

At block 1112, the ML model training application 136 updates one or more parameters of the first ML model 144 based on the determining at block 1110. For instance, the ML model training application 136 computes an error of the first ML model 144 based on the determined one or more other assets and updates the one or more parameters of the first ML model 144 based on the error (e.g., using a backpropagation process as discussed above with reference to FIG. 8).

FIG. 12 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, RAM 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, USB interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as CDMA, global system for mobile communications (GSM), LTE, WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A computer-implemented method of identifying and classifying infrastructure equipment assets along routes in a geographic region by analyzing a digital representation of the geographic region using artificial intelligence (AI) and computer image processing and analysis, the method comprising:
receiving, by a virtual audit application stored in non-transitory memory of a computer system and executable by a processor of the computer system, an indication of a type of equipment to be audited and a geographic region;
determining, by the virtual audit application, based on a location map database, geographic coordinate information of a route in the geographic region;
identifying, by the virtual audit application, from a geographic image database, a polyline representative of the route based on the geographic coordinate information;
traversing, by the virtual audit application, a plurality of points on the polyline;
retrieving, by the virtual audit application, from the geographic image database, based on geographic coordinate information associated with the plurality of points, a plurality of images of street views, each associated with a respective one of the plurality of points;
analyzing, by the virtual audit application, using one or more machine learning (ML) models, the plurality of images to identify and classify assets associated with the equipment, wherein the analyzing comprises adjusting views of the plurality of images for use by the one or more ML models;
generating, by the virtual audit application, a report that includes information associated with the identified assets and references to images of the identified assets; and
initiating, by the virtual audit application, based on the information in the report, an action associated with at least one of a record update, a record verification, or an infrastructure change recommendation.

2. The method of claim 1, further comprising:
retrieving, by the virtual audit application, from the geographic image database, second geographic coordinate information of a plurality of second points on the polyline; and
computing, by the virtual audit application, the geographic coordinate information of at least some of the plurality of points on the polyline based on an interpolation of the second geographic coordinate information of the plurality of second points.

3. The method of claim 1, wherein the retrieving the plurality of images comprises:
searching, by the virtual audit application, the geographic image database, for a most recent image in a proximity of an individual point of the plurality of points.

4. The method of claim 3, wherein the searching for the most recent image in the proximity of the individual point comprises:
retrieving, by the virtual audit application, from the geographic image database, timestamp information of images associated with neighboring points of the individual point on the polyline; and
comparing the timestamp information of the images associated with the neighboring points to select the most recent image in the proximity of the individual point.

5. The method of claim 4, wherein the neighboring points of the individual point are based on intersection points of a grid overlaid on the individual point.

6. The method of claim 1, wherein:
the adjusting the views of the plurality of images comprises:
adjusting at least one of a camera bearing or a field of view (FOV) of an individual image of the plurality of images to generate a first adjusted image, and
the analyzing the plurality of images further comprises:
processing the first adjusted image using a first ML model of the ML models to identify at least one of a pole or one or more assets of the assets associated with the equipment in the first adjusted image.

7. The method of claim 6, wherein:
the adjusting the views of the plurality of images further comprises:
adjusting at least one of a camera bearing or an FOV of the first adjusted image based on the at least one of the pole or the one or more assets identified by the first ML model to generate a second adjusted image, and
the analyzing the plurality of images comprises:
processing the second adjusted image using a second ML model of the ML models to identify the one or more assets in the second adjusted image.

8. The method of claim 6, wherein:
the adjusting the views of the plurality of images further comprises:
adjusting the camera bearing of the individual image to generate the first adjusted image to provide a left-side (LS) view or a right-side (RS) view with respect to a respective one of the plurality of points along the polyline; and
adjusting at least one of a camera bearing or an FOV of the first adjusted image with respect to the identified pole to generate a second adjusted image; and
adjusting at least one of a camera bearing, a pitch, or an FOV of the second adjusted image with respect to the one or more identified assets to generate a third adjusted image, and
the analyzing the plurality of images further comprises:
processing the third adjusted image, using a second ML model of the one or more ML models, to output an indication of the one or more assets in the third adjusted image and a classification of each of the one or more assets.

9. The method of claim 8, wherein:
the analyzing the plurality of images further comprises:
computing, based on the second adjusted image, an asset enclosing bounding box to enclose the one or more assets in the second adjusted image, and
the adjusting the at least one of the camera bearing, the pitch, or the FOV of the second adjusted image is further with respect to the computed asset enclosing bounding box.

10. The method of claim 1, wherein the information associated with identified assets in the report comprises, for each of the identified assets, at least one of:
a classification and a corresponding confidence score for the respective identified asset,
geographic coordinate information associated with the respective identified asset,
a camera bearing associated with the respective identified asset,
an FOV associated with the respective identified asset, or
a pitch associated with the respective identified asset.

11. The method of claim 1, wherein the analyzing the plurality of images further comprises:
assessing, by the virtual audit application, a condition of at least one of the identified assets.

12. The method of claim 1, wherein the identified assets comprise at least one of a power supply, a splice enclosure, telephony equipment, a tap, an amplifier, or a transformer.

13. A computer-implemented method of evaluating and updating a machine learning (ML) model for virtual auditing of infrastructure equipment based on rules associated with characteristics of the infrastructure equipment, the method comprising:
receiving, by a virtual audit application stored in non-transitory memory of a computer system and executable by a processor of the computer system, a type of equipment to be audited and a geographic region;
retrieving, by the virtual audit application, a plurality of images of the geographic region;
analyzing, by the virtual audit application, using one or more ML models, the plurality of images to identify and classify assets associated with the equipment, wherein the analyzing comprises:
processing a first image of the plurality of images using a first ML model of the one or more ML models to identify a first asset of the assets;
determining, by an ML model training application stored in the non-transitory memory of the computer system and executable by the processor of the computer system, that the first ML model fails to identify one or more other assets associated with the equipment based on rules associated with characteristics of the equipment; and
updating, by the ML model training application, based on the determining, one or more parameters of the first ML model.

14. The method of claim 13, wherein the updating the one or more parameters of the first ML model comprises:
training, by the ML model training application, the first ML model to further identify the one or more other assets determined based on the rules associated with the characteristics of the equipment.

15. The method of claim 13, wherein the rules associated with the characteristics of the equipment comprises at least one of:
an indication of a coexistence between a first type of assets and a second type of assets for the equipment, or
a comparison against an external data source having records of assets associated with the equipment.

16. The method of claim 13, wherein the one or more other assets determined based on the rules comprise at least one of a power supply, a splice enclosure, telephony equipment, a tap, an amplifier, or a transformer.

17. A computer-implemented method of updating an audit of infrastructure in a geographic region by analyzing a digital representation of the geographic region using artificial intelligence (AI) and computer image processing and analysis, the method comprising:
receiving, by a virtual audit application stored in non-transitory memory of a computer system and executable by a processor of the computer system, a type of equipment to be audited, a geographic region, and a previous audit record of the type of equipment in the geographic region;
determining, by the virtual audit application, a route in the geographic region;
retrieving, by the virtual audit application, from a geographic image database, first image acquisition timestamp information associated with a plurality of first images corresponding respectively to a plurality of locations along the route;
comparing, by the virtual audit application, the first image acquisition timestamp information to second image acquisition timestamp information associated with a plurality of second images of assets associated with the equipment identified at the plurality of locations in the previous audit record;
determining, by the virtual audit application, based on the comparing, that at least one of the plurality of first images associated with a first location of the plurality of locations is acquired more recently than a respective one of the plurality of second images associated with the same first location;
analyzing, by the virtual audit application, using one or more machine learning (ML) models, the at least one of the plurality of first images that is acquired more recently to identify and classify assets associated with the equipment; and
updating, by the virtual audit application, the previous audit record based on information about the assets identified from the at least one of the plurality of first images that is acquired more recently.

18. The method of claim 17, wherein the retrieving comprises:
searching, by the virtual audit application, the geographic image database, for each location of the plurality of locations, for a timestamp associated with a most recent image that is closest to the respective location.

19. The method of claim 17, further comprising:
determining, by the virtual audit application, that the route corresponds to a route used for auditing the type of equipment in the previous audit record.

20. The method of claim 17, wherein the identified assets comprise at least one of a power supply, a splice enclosure, telephony equipment, a tap, an amplifier, or a transformer.
